(19) United States
(12) Patent Application Publication
(10) Pub. No.: US 2021/0337419 A1
(43) Pub. Date: Oct. 28, 2021

(54) Background Data Transfer Handling

(71) Applicant: Telefonaktiebolaget LM Ericsson (PUBL), Stockholm (SE)

(72) Inventors: Susana Fernandez Alonso, MADRID (ES); Wenliang XU, SHANGHAI (CN)

(21) Appl. No.: 17/270,504

(22) PCT Filed: Aug. 24, 2018
(86) PCT No.: PCT/CN2018/102258

§ 371 Date: Feb. 23, 2021

(51) Int. Cl. H04W 28/02; H04W 8/24

(52) U.S. Cl. CPC H04W 28/0247; H04W 8/24; H04W 28/0215; H04W 28/0289

(57) ABSTRACT

There is provided a method of operating a server of a first network. The method comprises generating (100) an indication of an action to initiate for handling a transfer of background data from the server to a user equipment if the transfer fails to satisfy one or more conditions of an assigned background data transfer policy for the transfer. The method also comprises transmitting (102) the indication for a node of a second network to acquire the indication and initiate the action if the transfer fails to satisfy the one or more conditions of the assigned background data transfer policy.

### TECHNICAL FIELD

The present idea relates to a node, a server, a repository and methods of operating the same for handling a background data transfer.

### BACKGROUND

There exist mechanisms that allow a (third party) server to negotiate a background data transfer policy with an operator that fulfils the requirements of the server in order for that the server to start sending traffic to a group of user equipments (UEs). For example, such mechanisms exist for a services capability server (SCS) or application server (AS) of an evolved packet core (EPC) or a 4G network and for an application function (AF) of a 5G network. The SCS/AS of an EPC or a 4G network negotiates background data transfer policies with a policy and charging rules function (PCRF), whereas the AF of a 5G network negotiates background data transfer policies with a policy control function (PCF).

Generally, in order to negotiate a background data transfer policy in an EPC or a 4G network, the SCS/AS contacts a service capability exposure function (SCEF) using the Nt interface that interacts with the PCRF to negotiate the background data transfer policy that fulfils the requirements of the SCS/AS. Once negotiated, the background data transfer policy is usually stored in the subscription profile repository (SPR) together with a Reference ID that identifies the related policy in future transactions. Such Reference ID is generally referenced by a UE for starting the background data transfer. When the SCS/AS needs to transfer background data traffic to the UE, it will contact the PCRF either directly by acting as an application function (AF) or via the SCEF. The SCS/AS provides the Reference ID to the PCRF for each UE individually, together with SCS/AS session information, via the Rx interface. The PCRF retrieves the background data transfer policy stored in the SPR using the received Reference ID. If the AF request is within a time window provided in the previously negotiated background data transfer policy, the PCRF derives the corresponding policy and charging control (PCC) rules and reserves the resources according to the demands of the AS.

The same process occurs in order to negotiate a background data transfer policy in a 5G network, except the process involves the AF instead of the SCS/AS, a network exposure function (NEF) instead of the SCEF, the N30 interface instead of the Nt interface, a unified data repository (UDR) instead of the SPR, the PCF instead of the PCRF, and the N5 interface instead of the Rx interface.

When negotiating a background data transfer policy from a server to a UE, one or more conditions are agreed that the background data transfer from the server to the UE must meet. However, it may be the case that the UE breaches one or more of these agreed conditions and there currently exists no appropriate mechanism for handling such a breach. For example, currently, operators are only aware of a breach from offline information and the operators simply apply a penalty to servers involved in the transfer for which the breach occurs. This mechanism is not appropriate as it can be difficult for operators to manage the enforcement of the penalties, since different servers may require different penalties depending on the scenario and the conditions that are breached, which can make the process complex and resource heavy.

There is thus a need for an improved means for handling a background data transfer, which overcomes at least some of the problems associated with existing mechanisms.

### SUMMARY

It is an object to obviate or eliminate at least some of the above disadvantages associated with existing mechanisms and provide an improved mechanism for handling a background data transfer.

Therefore, according to an aspect of the idea, there is provided a method of operating a server of a first network. The method comprises generating an indication of an action to initiate for handling a transfer of background data from the server to a user equipment if the transfer fails to satisfy one or more conditions of an assigned background data transfer policy for the transfer. The method also comprises transmitting the indication for a node of a second network to acquire the indication and initiate the action if the transfer fails to satisfy the one or more conditions of the assigned background data transfer policy.

The idea thus provides an improved mechanism for handling a background data transfer. This mechanism is improved as the server is able to control the manner in which the background data transfer is handled (e.g. whether the background data transfer is disallowed or allowed and under what conditions) when one or more conditions of the background data transfer policy are broken, since the server of the first network (rather than any node of the second network) provides the action to be taken in this situation. In this way, different server needs can be satisfied and the network can thus be used in the optimum way according to the background data transfer. This allows for the reservation of resources and thus provides an improved user experience. The node (e.g. an operator) can still provide resources for the background data transfer but under new negotiated conditions. This allows the server (e.g. an application or service provider) to still provide the data transfer even though the original conditions cannot be satisfied. The user experience is improved as the background data can be transferred even in cases where the original conditions are not satisfied.

In some embodiments, the method may further comprise, if the transfer fails to satisfy the one or more conditions of the assigned background data transfer policy, receiving a notification from the node that the transfer fails to satisfy the one or more conditions of the assigned background data transfer policy. In this way, both the node and the server are aware of the transfer failing to satisfy the one or more conditions of the assigned background data transfer policy, such that the transfer can still take place if it is acceptable by both the node (e.g. an operator) and a server (e.g. an application or service provider) under new conditions.

According to another aspect of the idea, there is provided a server of a first network. The server comprises processing circuitry. The processing circuitry of the server is configured to generate an indication of an action to initiate for handling a transfer of background data from the server to a user equipment if the transfer fails to satisfy one or more conditions of an assigned background data transfer policy for the transfer. The processing circuitry of the server is also configured to transmit the indication for a node of a second network to acquire the indication and initiate the action if the transfer fails to satisfy the one or more conditions of the assigned background data transfer policy. The idea thus provides the advantages discussed earlier in respect of the method of operating the server of the first network.

According to another aspect of the idea, there is provided a method of operating node of a second network. The method comprises receiving, from a server of a first network, a request to transfer background data from the server to a user equipment and acquiring an assigned background data transfer policy for the transfer and an indication generated by the server of an action to initiate for handling the transfer if the transfer fails to satisfy one or more conditions of the assigned background data transfer policy. The method also comprises monitoring the transfer to check whether the transfer satisfies the one or more conditions of the assigned background data transfer policy and, if the transfer fails to satisfy the one or more conditions of the assigned background data transfer policy, initiating the action. The idea thus provides the advantages discussed earlier in respect of the method of operating the server of the first network.

In some embodiments, the one or more conditions of the assigned background data transfer policy may comprise any one or more of a maximum volume of background data for the transfer, a maximum duration for the transfer and a predefined area within the second network for the transfer. The monitoring of any one or more of these conditions allows the node (e.g. the operator) to discover that the request for the transfer of background data cannot be satisfied according to the background data transfer policy agreed upon with the server (e.g. the application or service provider).

This allows the node to renegotiate the one or more conditions or terminate the transfer.

In some embodiments, the one or more conditions of the assigned background data transfer policy may comprise a maximum volume of background data for the transfer and the action may be initiated if the volume of background data for the transfer exceeds the maximum volume. In this way, if the server (e.g. the application or service provider) exceeds an authorized volume, the node (e.g. the operator) has a mechanism that allows it to either renegotiate a new volume of background data for the transfer or terminate the transfer if new conditions are not acceptable.

In some embodiments, the one or more conditions of the assigned background data transfer policy may comprise a maximum duration for the transfer and the action may be initiated if the duration of the transfer exceeds the maximum duration. In this way, if the server (e.g. the application or service provider) exceeds an authorized duration, the node (e.g. the operator) has a mechanism that allows it to either renegotiate a new duration for the transfer or terminate the transfer if new conditions are not acceptable.

In some embodiments, the one or more conditions of the assigned background data transfer policy may comprise a predefined area within the second network for the transfer and the action may be initiated if the transfer occurs outside the predefined area within the second network. In this way, if the server (e.g. the application or service provider) wants to transfer background data outside the predefined area, the node (e.g. the operator) has a mechanism that allows it to either renegotiate the authorized areas or terminate the transfer if new conditions are not acceptable.

In some embodiments, the action may comprise disallowing the transfer, allowing the transfer only according to one or more conditions of a default background data transfer policy of the node, or allowing the transfer only according to one or more revised conditions of the assigned background data transfer policy, wherein the one or more revised conditions are indicated by the server. Thus, the node (e.g. the operator) has various options available that can be selected depending on an agreement between the node and the server (e.g. the application or service provider), satisfying new demands if possible.

In some embodiments, the method may further comprise, if the transfer fails to satisfy the one or more conditions of the assigned background data transfer policy, transmitting a notification to the server of the first network that the transfer fails to satisfy the one or more conditions of the assigned background data transfer policy. That way, the server (e.g. the application or service provider) has knowledge of the transfer failing to satisfy the one or more conditions of the assigned background data transfer policy, such that the server can react and still provide the data transfer under new conditions if they are acceptable.

According to another aspect of the idea, there is provided a node of a second network. The node comprises processing circuitry. The processing circuitry of the node is configured to receive, from a server of a first network, a request to transfer background data from the server to a user equipment and acquire an assigned background data transfer policy for the transfer and an indication generated by the server of an action to initiate for handling a transfer if the transfer fails to satisfy one or more conditions of the assigned background data transfer policy. The processing circuitry of the node is also configured to monitor the transfer to check whether the transfer satisfies the one or more conditions of the assigned background data transfer policy and, if the transfer fails to satisfy the one or more conditions of the assigned background data transfer policy, initiate the action. The idea thus provides the advantages discussed earlier in respect of the method of operating the server of the first network.

In some embodiments, the one or more conditions of the assigned background data transfer policy may comprise any one or more of a maximum volume of background data for the transfer, a maximum duration for the transfer, and a predefined area within the second network for the transfer. The monitoring of any one or more of these conditions allows the node (e.g. the operator) to discover that the request for the transfer of background data cannot be satisfied according to the background data transfer policy agreed upon with the server (e.g. the application or service provider). This allows the node to renegotiate the one or more conditions or terminate the transfer.

In some embodiments, the one or more conditions of the assigned background data transfer policy may comprise a maximum volume of background data for the transfer and the processing circuitry may be configured to initiate the action if the volume of background data for the transfer exceeds the maximum volume. In this way, if the server (e.g. the application or service provider) exceeds an authorized volume, the node (e.g. the operator) has a mechanism that allows it to either renegotiate a new volume of background data for the transfer or terminate the transfer if new conditions are not acceptable.

In some embodiments, the one or more conditions of the assigned background data transfer policy may comprise a maximum duration for the transfer and the processing circuitry may be configured to initiate the action to the user equipment if the duration of the transfer to the user equipment exceeds the maximum duration. In this way, if the server (e.g. the application or service provider) exceeds an authorized duration, the node (e.g. the operator) has a mechanism that allows it to either renegotiate a new duration for the transfer or terminate the transfer if new conditions are not acceptable.

In some embodiments, the one or more conditions of the assigned background data transfer policy may comprise a predefined area within the second network for the transfer and the processing circuitry may be configured to initiate the action if the transfer occurs outside the predefined area within the second network. In this way, if the server (e.g. the application or service provider) wants to transfer background data outside the predefined area, the node (e.g. the operator) has a mechanism that allows it to either renegotiate the authorized areas or terminate the transfer if new conditions are not acceptable.

In some embodiments, the action may comprise disallowing the transfer, allowing the transfer only according to one or more conditions of a default background data transfer policy of the node, or allowing the transfer only according to one or more revised conditions of the assigned background data transfer policy, wherein the one or more revised conditions are indicated by the server. Thus, the node (e.g. the operator) has various options available that can be selected depending on an agreement between the node and the server (e.g. the application or service provider), satisfying new demands if possible.

In some embodiments, the processing circuitry may be further configured to, if the transfer fails to satisfy the one or more conditions of the assigned background data transfer policy, transmit a notification to the server of the first network that the transfer fails to satisfy the one or more conditions of the assigned background data transfer policy. That way, the server (e.g. the application or service provider) is provided with knowledge of the transfer failing to satisfy the one or more conditions of the assigned background data transfer policy, such that the server can react and still provide the data transfer under new conditions if they are acceptable.

According to another aspect of the idea, there is provided a method of operating a repository of a second network. The method comprises receiving an assigned background data transfer policy for a transfer of background data from a server of a first network to a user equipment and an indication generated by the server of an action to initiate for handling the transfer if the transfer fails to satisfy one or more conditions of the assigned background data transfer policy. The method also comprises storing the assigned background data transfer policy and the indication of the action for a node of a second network to acquire in order to initiate the action if the transfer fails to satisfy the one or more conditions of the assigned background data transfer policy. The idea thus provides the advantages discussed earlier in respect of the method of operating the server of the first network.

According to another aspect of the idea, there is provided a repository of a second network. The repository is configured to receive a background data transfer policy assigned for a transfer of background data from a server of a first network to a user equipment and an indication generated by the server of an action to initiate for handling the transfer if the transfer fails to satisfy one or more conditions of the assigned background data transfer policy. The repository is also configured to store the assigned background data transfer policy and the indication of the action for a node of a second network to acquire in order to initiate the action if the transfer fails to satisfy the one or more conditions of the assigned background data transfer policy. The idea thus provides the advantages discussed earlier in respect of the method of operating the server of the first network.

According to another aspect of the idea, there is provided a computer program product comprising a carrier containing instructions for causing processing circuitry to perform a method as described earlier. The idea thus provides the advantages discussed earlier in respect of the method of operating the node, server, and repository.

Therefore, an improved means for handling a background data transfer is provided.

### BRIEF DESCRIPTION OF THE DRAWINGS

For a better understanding of the idea, and to show how it may be put into effect, reference will now be made, by way of example, to the accompanying drawings, in which:

FIG. 1 is a block diagram illustrating a server according to an embodiment;

FIG. 2 is a block diagram illustrating a method of operating a server according to an embodiment;

FIG. 3 is a block diagram illustrating a node according to an embodiment;

FIG. 4 is a block diagram illustrating a method of operating a node according to an embodiment;

FIG. 5 is a block diagram illustrating a repository according to an embodiment;

FIG. 6 is a block diagram illustrating a method of operating a repository according to an embodiment;

FIG. 7 is a block diagram illustrating a network according to an embodiment;

FIG. 8 is a signalling diagram illustrating the signals in a network according to an embodiment;

FIG. 9 is a block diagram illustrating a server according to an embodiment;

FIG. 10 is a block diagram illustrating a node according to an embodiment; and

FIG. 11 is a block diagram illustrating a repository according to an embodiment.

### DETAILED DESCRIPTION

As mentioned earlier, there is described herein an improved mechanism for handling a background data transfer. A background data transfer referred to herein is the transfer of any type of background data. A background data transfer can be defined as a transfer of data in the background. That is, a background data transfer can be any data transfer that occurs without, or irrespective of, user interaction. Background data may refer to non-time critical data that a server (e.g. a service or application of the server) needs to send to a user equipment (UE). The server may have knowledge of the timing for the transmission of background data and the amount of background data for transmission. Examples of background data include, but are not limited to, software upgrades or audio/video data for future use. The background data transfer described herein is from a server of a first network to a user equipment (UE).

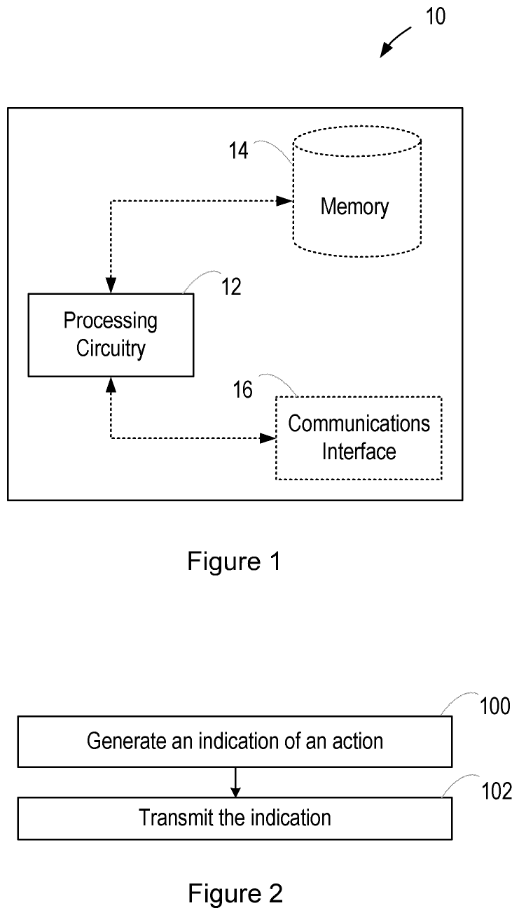

FIG. 1 illustrates a server 10 of a first network in accordance with an embodiment. In embodiments where the first network is an evolved packet core (EPC) or a 4G network, the server 10 may be a services capability server (SCS) or an application server (AS). In embodiments where the first network is a 5G network, the server 10 may be an application function (AF).

As illustrated in FIG. 1, the server 10 comprises processing circuitry (or logic) 12. The processing circuitry 12 controls the operation of the server 10 and can implement the method described herein in relation to the server 10. The processing circuitry 12 can comprise one or more processors, processing units, multi-core processors or modules that are configured or programmed to control the server 10 in the manner described herein. In particular implementations, the processing circuitry 12 can comprise a plurality of software and/or hardware modules that are each configured to perform, or are for performing, individual or multiple steps of the method described herein in relation to the server 10.

Briefly, the processing circuitry 12 of the server 10 is configured to generate an indication of an action to initiate for handling a transfer of background data from the server 10 to a user equipment if the transfer fails to satisfy one or more conditions of an assigned background data transfer policy for the transfer. The processing circuitry 12 of the server 10 is also configured to transmit the indication for a node of a second network to acquire the indication and initiate the action if the transfer fails to satisfy the one or more conditions of the assigned background data transfer policy.

As illustrated in FIG. 1, in some embodiments, the server 10 may optionally comprise a memory 14. The memory 14 of the server 10 can be connected to the processing circuitry 12 of the server 10. In some embodiments, the memory 14 of the server 10 may be configured to store program code or instructions that can be executed by the processing circuitry 12 of the server 10 to perform the method described herein in relation to the server 10. Alternatively or in addition, the memory 14 of the server 10 can be configured to store any requests, policies, indications, information, data, notifications, signals, or similar, that are described herein. The processing circuitry 12 of the server 10 may be configured to control the memory 14 of the server 10 to store any requests, policies, indications, information, data, notifications, signals, or similar, that are described herein.

The memory 14 of the server 10 can comprise a volatile memory or a non-volatile memory. In some embodiments, the memory 14 of the server 10 may comprise a non-transitory media. Examples of the memory 14 of the server 10 include, but are not limited to, a random access memory (RAM), a read only memory (ROM), a mass storage media such as a hard disk, a removable storage media such as a compact disk (CD) or a digital video disk (DVD), and/or any other memory.

In some embodiments, as illustrated in FIG. 1, the server 10 may optionally comprise a communications interface 16. The communications interface 16 of the server 10 can be connected to the processing circuitry 12 of the server 10. The communications interface 16 of the server 10 may be operable to communicate with other nodes (such as any one or more of a node of a second network, a repository, or any other nodes, or any combination of other nodes). For example, the communications interface 16 of the server 10 can be configured to transmit to and/or receive from other nodes requests, policies, indications, information, data, signals, or similar, that are described herein.

The processing circuitry 12 of the server 10 may be configured to control the communications interface 16 of the server 10 to transmit to and/or receive from other nodes requests, policies, indications, information, data, notifications, signals, or similar, that are described herein.

It will be appreciated that FIG. 1 only shows the components required to illustrate an embodiment of the server 10 and, in a practical implementation, the server 10 may comprise additional or alternative components to those shown.

FIG. 2 is a flowchart illustrating a method of operating the server 10 of a first network in accordance with an embodiment. The method of FIG. 2 can be performed by or under the control of the processing circuitry 12 of the server 10.

With reference to FIG. 2, at block 100, an indication is generated. More specifically, the processing circuitry 12 of the server 10 generates the indication. The indication is of an action to initiate for handling a transfer of background data from the server 10 to a user equipment if the transfer fails to satisfy one or more conditions of an assigned background data transfer policy for the transfer. At block 102 of FIG. 2, the indication is transmitted for a node of a second network to acquire the indication and initiate the action if the transfer fails to satisfy the one or more conditions of the assigned background data transfer policy. More specifically, the processing circuitry 12 of the server 10 transmits the indication.

Although not illustrated in FIG. 2, in some embodiments, if the transfer fails to satisfy the one or more conditions of the assigned background data transfer policy, a notification may be received from the node 20 that the transfer fails to satisfy the one or more conditions of the assigned background data transfer policy. Thus, in some embodiments, the processing circuitry 12 of the server 10 can be configured to receive this notification from the node 20.

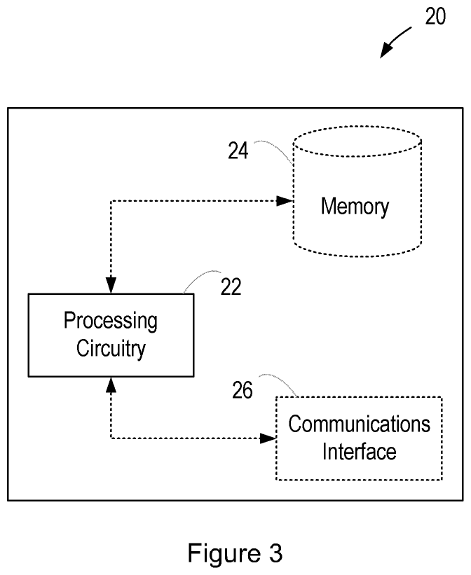

FIG. 3 illustrates a node 20 of a second network in accordance with an embodiment. In embodiments where the second network is an evolved packet core (EPC) or a 4G network, the node 20 may be a policy and charging rules function (PCRF). In embodiments where the second network is a 5G network, the node 20 can be a policy control function (PCF). The node 20 described herein may also be referred to as an “operator node” or a “policy management node”.

As illustrated in FIG. 3, the node 20 comprises processing circuitry (or logic) 22. The processing circuitry 22 controls the operation of the node 20 and can implement the method described herein in relation to the node 20 of the second network. The processing circuitry 22 can comprise one or more processors, processing units, multi-core processors or modules that are configured or programmed to control the node 20 in the manner described herein. In particular implementations, the processing circuitry 22 can comprise a plurality of software and/or hardware modules that are each configured to perform, or are for performing, individual or multiple steps of the method described herein in relation to the node 20.

Briefly, the processing circuitry 22 of the node 20 is configured to receive, from a server 10 of a first network, a request to transfer background data from the server to a user equipment. The processing circuitry 22 of the node 20 is also configured to acquire an assigned background data transfer policy for the transfer and an indication generated by the server of an action to initiate for handling a transfer if the transfer fails to satisfy one or more conditions of the assigned background data transfer policy. The processing circuitry 22 of the node 20 is further configured to monitor the transfer to check whether the transfer satisfies the one or more conditions of the assigned background data transfer policy and, if the transfer fails to satisfy the one or more conditions of the assigned background data transfer policy, initiate the action.

As illustrated in FIG. 3, in some embodiments, the node 20 may optionally comprise a memory 24. The memory 24 of the node 20 can be connected to the processing circuitry 22 of the node 20. In some embodiments, the memory 24 of the node 20 may be configured to store program code or instructions that can be executed by the processing circuitry 22 of the node 20 to perform the method described herein in relation to the node 20. Alternatively or in addition, the memory 24 of the node 20 can be configured to store any requests, policies, indications, information, data, notifications, signals, or similar, that are described herein. The processing circuitry 22 of the node 20 may be configured to control the memory 24 of the node 20 to store any requests, policies, indications, information, data, notifications, signals, or similar, that are described herein.

The memory 24 of the node 20 can comprise a volatile memory or a non-volatile memory. In some embodiments, the memory 24 of the node 20 may comprise a non-transitory media. Examples of the memory 24 of the node 20 include, but are not limited to, a random access memory (RAM), a read only memory (ROM), a mass storage media such as a hard disk, a removable storage media such as a compact disk (CD) or a digital video disk (DVD), and/or any other memory.

In some embodiments, as illustrated in FIG. 3, the node 20 may optionally comprise a communications interface 26. The communications interface 26 of the node 20 can be connected to the processing circuitry 22 of the node 20. The communications interface 26 of the node 20 may be operable to communicate with other nodes (such as any one or more of a server 10 of a first network, a repository, or any other nodes, or any combination of other nodes). For example, the communications interface 26 of the node 20 can be configured to transmit to and/or receive from other nodes requests, policies, indications, information, data, notifications, signals, or similar, that are described herein. The processing circuitry 22 of the node may be configured to control the communications interface 26 of the node 20 to transmit to and/or receive from other nodes requests, policies, indications, information, data, notifications, signals, or similar, that are described herein.

It will be appreciated that FIG. 3 only shows the components required to illustrate an embodiment of the node 20 and, in a practical implementation, the node 20 may comprise additional or alternative components to those shown.

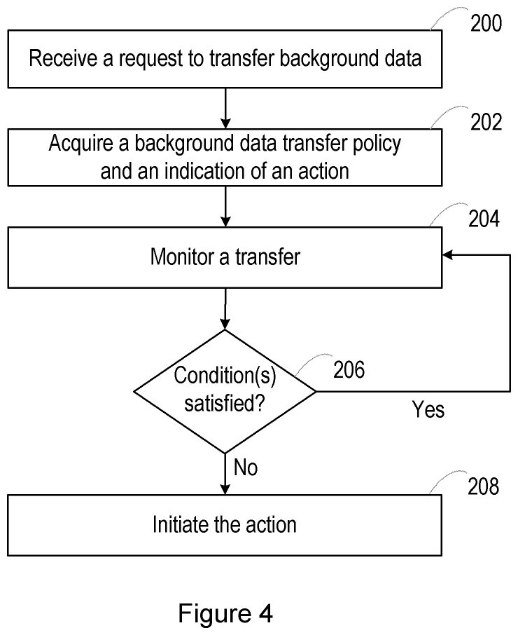

FIG. 4 is a flowchart illustrating a method of operating the node 20 of a second network in accordance with an embodiment. The method of FIG. 4 can be performed by or under the control of the processing circuitry 22 of the node 20.

With reference to FIG. 4, at block 200, a request to transfer background data from the server to a user equipment is received from a server 10 of a first network. More specifically, the processing circuitry 22 of the node 20 receives the request. The request may be received via a network interface, such as the Rx interface where the first and second network are part of an evolved packet core (EPC) or a 4G network, or the N5 interface where the first and second network are part of a 5G network.

At block 202, an assigned background data transfer policy for the transfer and an indication is generated by the server 10 is acquired. More specifically, the processing circuitry 22 of the node 20 acquires the assigned background data transfer policy and the indication. The indication is of an action to initiate for handling the transfer if the transfer fails to satisfy one or more conditions of the assigned background data transfer policy. In some embodiments, acquiring the assigned background data transfer policy at block 202 can comprise the processing circuitry 22 of the node 20 assigning the background data transfer policy for the transfer. Thus, in some embodiments, the processing circuitry 22 of the node 20 can be configured to assign the background data transfer policy for the transfer. In this way, the node 20 itself may assign the background data transfer policy for the transfer according to some embodiments.

In other embodiments, another node (e.g. another PCRF or PCF) may assign the background data transfer policy for the transfer. In these embodiments, when the policy is assigned by another node, acquiring the assigned background data transfer policy at block 202 can comprise the processing circuitry 22 of the node 20 retrieving the assigned background data transfer policy from a repository of the second network. For example, the node that assigned the background data transfer policy can be configured to store the assigned background data transfer policy in the repository of the second network. Thus, in some embodiments, the processing circuitry 22 of the node 20 can be configured to retrieve the assigned background data transfer policy from the repository of the second network.

In some embodiments, the assigned background data transfer policy may be stored in the repository of the second network with a reference that identifies the assigned background data transfer policy (which is referred to as a “Reference ID”). Thus, in some embodiments, the assigned background data transfer policy can be retrieved using this reference. In some embodiments, the processing circuitry 22 of the node 20 can be configured to retrieve the assigned background data transfer policy from the repository of the second network via a network interface, such as the Nt interface where the first and second network are part of an EPC network or 4G network, or the N30 interface where the first and second network are part of a 5G network.

In some embodiments, acquiring the indication of the action may comprise the processing circuitry 22 of the node 20 retrieving the indication of the action from the repository of the second network. Thus, in some embodiments, the processing circuitry 22 of the node 20 can be configured to retrieve the indication of the action from the repository of the second network. In other embodiments, the request received from the server 10 may comprise the indication of the action.

Returning back to FIG. 4, at block 204, the transfer is monitored to check (at block 206) whether the transfer satisfies the one or more conditions of the assigned background data transfer policy. More specifically, the processing circuitry 22 of the node 20 monitors the transfer. If the transfer fails to satisfy the one or more conditions of the assigned background data transfer policy, the process move to block 208 at which the action is initiated. More specifically, the processing circuitry 22 of the node 20 initiates the action.

Although not illustrated in FIG. 4, in some embodiments, if the transfer fails to satisfy the one or more conditions of the assigned background data transfer policy, a notification may be transmitted to the server 10 of the first network 402 that the transfer fails to satisfy the one or more conditions of the assigned background data transfer policy. Thus, in some embodiments, the processing circuitry 22 of the node 20 can be configured to transmit such a notification to the server 10.

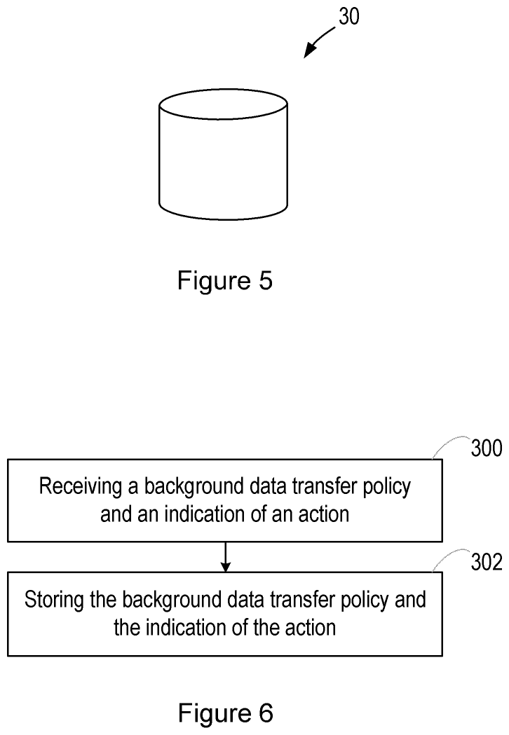

FIG. 5 illustrates a repository 30 of the second network in accordance with an embodiment. In embodiments where the second network is an evolved packet core (EPC) or a 4G network, the repository 30 may be a subscription profile repository (SPR). In embodiments where the second network is a 5G network, the repository 30 can be a unified data repository (UDR).

The repository 30 can be configured to store any requests, policies, indications, information, data, notifications, signals, or similar, that are described herein. The processing circuitry 22 of the node 20 may be configured to control the repository 30 to store any requests, policies, indications, information, data, notifications, signals, or similar, that are described herein. The repository 30 can comprise a volatile repository or a non-volatile repository. In some embodiments, the repository 30 may comprise a non-transitory media. Examples of the repository 30 include, but are not limited to, a random access memory (RAM), a read only memory (ROM), a mass storage media such as a hard disk, a removable storage media such as a compact disk (CD) or a digital video disk (DVD), and/or any other memory.

Briefly, the repository 30 is configured to receive a background data transfer policy assigned for a transfer of background data from a server 10 of a first network to a user equipment and an indication generated by the server 10 of an action to initiate for handling the transfer if the transfer fails to satisfy one or more conditions of the assigned background data transfer policy. The repository 30 is also configured to store the assigned background data transfer policy and the indication of the action for a node 20 of a second network to acquire in order to initiate the action if the transfer fails to satisfy the one or more conditions of the assigned background data transfer policy.

FIG. 6 is a flowchart illustrating a method of operating the repository 30 of the second network in accordance with an embodiment.

With reference to FIG. 6, at block 300, an assigned background data transfer policy and an indication are received. More specifically, the repository 30 receives the assigned background data transfer policy and the indication. The assigned background data transfer policy is for a transfer of background data from the server 10 of a first network to a user equipment. The indication is generated by the server 10 and the indication is of an action to initiate for handling the transfer if the transfer fails to satisfy one or more conditions of the assigned background data transfer policy.

At block 302, the assigned background data transfer policy and the indication of the action is stored for the node 20 of the second network to acquire in order to initiate the action if the transfer fails to satisfy the one or more conditions of the assigned background data transfer policy. More specifically, the repository 30 stores the assigned background data transfer policy and the indication. In some embodiments, the background data transfer policy may be assigned for the transfer by the same node as the node 20 that acquires the policy in order to initiate the action if the transfer fails to satisfy the one or more conditions of the assigned background data transfer policy. In other embodiments, the background data transfer policy may be assigned for the transfer by a different node to the node 20 that acquires the policy in order to initiate the action if the transfer fails to satisfy the one or more conditions of the assigned background data transfer policy.

The one or more conditions of the assigned background data transfer policy that are referred to herein may, for example, comprise any one or more of a maximum volume of background data for the transfer, a maximum duration (e.g. a set time window) for the transfer, and a predefined area within the second network for the transfer. In some embodiments where the one or more conditions of the assigned background data transfer policy comprise a maximum volume of background data for the transfer, the action may be initiated if the volume of background data for the transfer exceeds the maximum volume. In some embodiments where the one or more conditions of the assigned background data transfer policy comprise a maximum duration (e.g. a set time window) for the transfer, action may be initiated if the duration of the transfer exceeds the maximum duration (e.g. if the transfer continues beyond the set time window). In some embodiments where the one or more conditions of the assigned background data transfer policy comprise a predefined area within the second network 404 for the transfer, the action may initiated if the transfer occurs outside the predefined area within the second network 404. The transfer may, for example, occur outside the predefined area within the second network 404 due to the movement of the user equipment.

Although some examples have been provided for the one or more conditions of the assigned background data transfer policy and the actions that may be taken if such one or more conditions are not satisfied, it will be understood that the assigned background data transfer policy may comprise any other conditions, or any combination of conditions, and any other corresponding actions.

In some embodiments, the action referred to herein may comprise disallowing (or terminating) the transfer. In other embodiments, the action referred to herein may comprise allowing the transfer only according to one or more conditions of a default background data transfer policy of the node 20. In yet other embodiments, the action referred to herein may comprise allowing the transfer only according to one or more revised conditions of the assigned background data transfer policy. In some of these embodiments, the one or more revised conditions may be indicated by the server 10. In some embodiments where the server 10 indicates the one or more revised conditions, a default background data transfer policy may also be negotiated with the node 20.

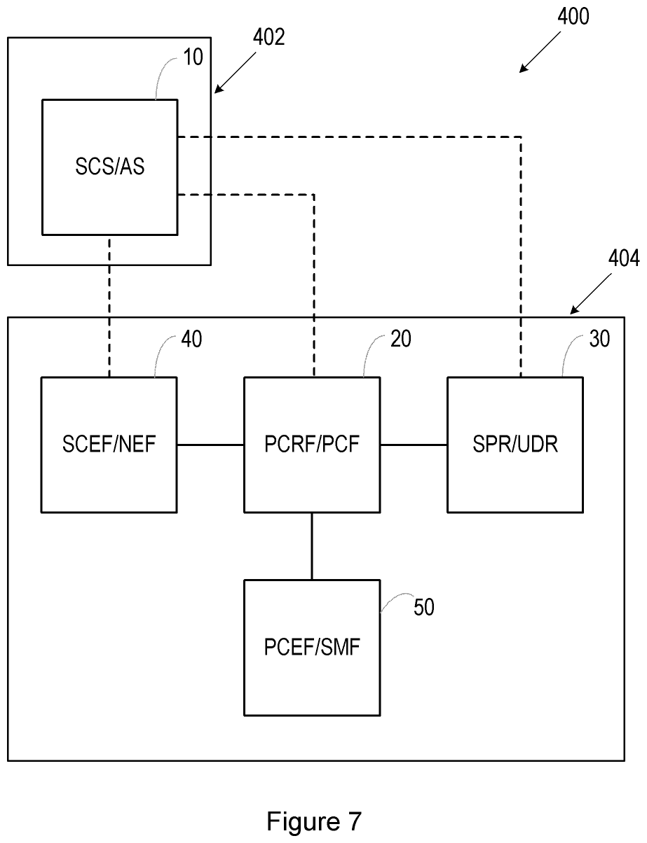

FIG. 7 illustrates a network 400 in accordance with an embodiment. The network 400 comprises a first network 402 and a second network 404. The first network 402 and the second network 404 can be different networks. As illustrated in FIG. 7, the first network 402 comprises the server 10 (e.g. the SCS, AS, or AF) described earlier and the second network 404 comprises the node 20 (e.g. the PCRF or PCF) and the repository 30 (e.g. the SPR or UDR) described earlier.

In some embodiments, as illustrated in FIG. 7, the second network 404 can comprise an exposure node 40. In embodiments where the second network 404 is an evolved packet core (EPC) or a 4G network, the exposure node 40 may be a service capability exposure function (SCEF). In embodiments where the second network 404 is a 5G network, the exposure node 40 may be a network exposure function (NEF).

In some embodiments, as also illustrated in FIG. 7, the second network 404 may comprise an enforcement or management node 50. In embodiments where the second network 404 is an evolved packet core (EPC) or a 4G network, the enforcement or management node 50 may be a policy and charging enforcement function (PCEF). In embodiments where the second network 404 is a 5G network, the enforcement or management node 50 may be a session management function (SMF).

As illustrated in FIG. 7, the server 10 can be configured to communicate with and/or connect to any one or more of the node 20, the repository 30 and the exposure node 40. Similarly, any one or more of the node 20, the repository 30 and the exposure node 40 can be configured to communicate with and/or connect to the server 10. As also illustrated in FIG. 7, the node 20 can be configured to communicate with and/or connect to any one or more of the repository 30, the exposure node 40 and the enforcement or management node 50. Similarly, one or more of the repository 30, the exposure node 40 and the enforcement or management node 50 can be configured to communicate with and/or connect to the node 20.

Although not illustrated in the figures, the background data transfer described herein can be via a network interface. In embodiments where the first and second networks 402, 404 are part of an evolved packet core (EPC) or a 4G network, the background data transfer can be via the Rx interface. In embodiments where the first and second networks are part of a 5G network, the background data transfer can be via the N5 interface.

Although it has been described herein that “an” assigned background data transfer policy is acquired by the node 20, it will be understood that, in some embodiments, a plurality of assigned background data transfer policies may be acquired by the node 20. In some of these embodiments, the processing circuitry 22 of the node 20 may be configured to select an assigned background data transfer policy of the plurality of assigned background data transfer policies. In some embodiments, the server 10 may indicate to the node 20 which assigned background data transfer policy of the plurality of assigned background data transfer policies the node 20 is to select. In other words, the server 10 can select an assigned background transfer policy from the plurality of background data transfer policies according to some embodiments. Thus, in these embodiments, the node 20 can be configured to select the assigned background data transfer policy that is indicated by the server 10.

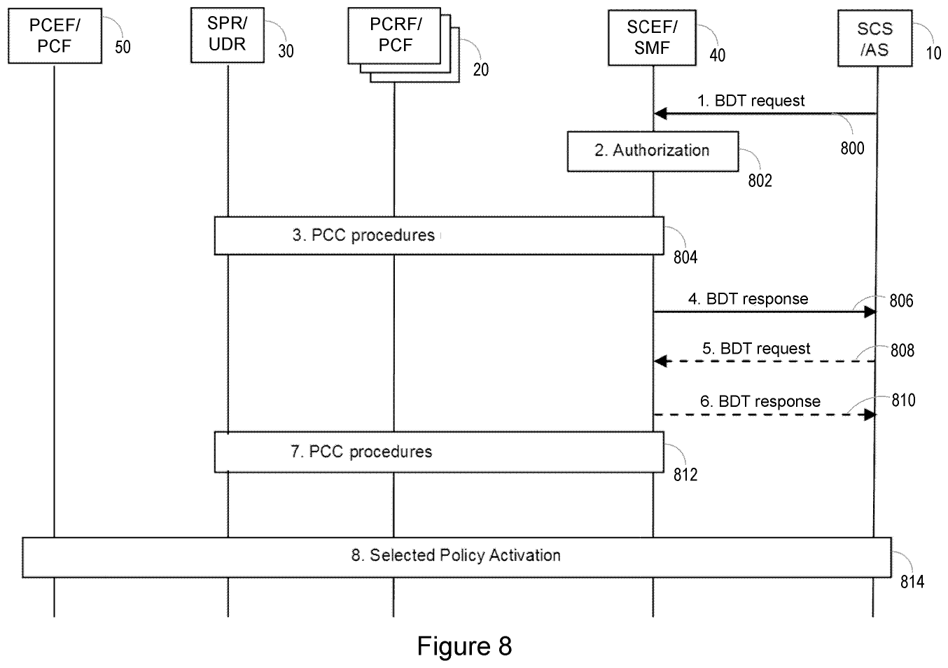

FIG. 8 is a signalling diagram illustrating the signals in a network 400 in accordance with an embodiment. The network 400 comprises the first network 402 and the second network 404 described earlier. The network 400 in accordance with this embodiment comprises the server 10 (e.g. the SCS, AS, or AF) of the first network 402 and the node 20 (e.g. the PCRF or PCF), the repository 30 (e.g. the SPR or UDR), the exposure node 40 (e.g. the SCEF or SMF) and the enforcement or management node 50 (e.g. the PCEF or PCF) of the second network 404 described earlier. The operation of the network 400 according to the example embodiment will now be described with reference to FIG. 8.

Firstly, the server 10 of the first network 402 generates an indication of an action to initiate for handling a transfer of background data from the server 10 to a user equipment if the transfer fails to satisfy one or more conditions of an assigned background data transfer policy for the transfer. The server 10 transmits the indication for the node 20 of the second network 404 to acquire the indication and initiate the action if the transfer fails to satisfy the one or more conditions of the assigned background data transfer policy.

With reference to FIG. 8, as illustrated by arrow 800, the server 10 transmits a request to transfer background data from the server 10 of the first network 402 to a user equipment. In other words, a background data transfer (BDT) request 800 is transmitted from the server 10. In the example embodiments illustrated in FIG. 8, the BDT request 800 comprises the indication. However, it will be understood that in other embodiments the indication may be acquired by the node 20 in another way, e.g. by retrieval from the repository 30. Thus, in addition to the information provided as part of a BDT request according to current techniques, the server 10 described herein advantageously includes new data in the form of the indication of the action to initiate for handling a transfer of background data from the server 10 to a user equipment if the transfer fails to satisfy one or more conditions of an assigned background data transfer policy for the transfer. The indication may be labelled, e.g. “Required Action”.

Following the transmission of the BDT request 800 comprising the indication, the BDT request 800 is received by the exposure node 40 and, at block 802, the exposure node 40 authorizes the BDT request 800. The exposure node 40 then contacts the node 20. Thus, in some embodiments, the node 20 receives the BDT request 800 from the server 10 via the exposure node 40. However, it will be understood that in other embodiments, the node 20 may receive the BDT request 800 directly from the server 10. As mentioned earlier, according to the example embodiment illustrated in FIG. 8, the BDT request 800 comprises the indication of the action. If the action requires a default policy, the BDT request 800 may also comprise an indication of one or more conditions of that default policy.

When the node 20 receives the BDT request 800, at block 804, the node 20 acquires an assigned background data transfer policy for the transfer. According to the example embodiment illustrated in FIG. 8, at block 804, the node 20 acquires the assigned background data transfer policy for the transfer by retrieving the assigned background data transfer policy from the repository 30. However, it will be understood that in other embodiments the assigned background data transfer policy may be acquired by the node 20 in another way, e.g. the node 20 may itself assign the background data transfer policy.

Also, at block 804, the node 20 transmits the assigned background data transfer policy to the server 10. In some embodiments, such as that illustrated in FIG. 8, this transmission is via the exposure node 40. For example, in some embodiments, the node 20 can transmit the assigned background data transfer policy to the exposure node 40 and the exposure node 40 may then transmit (or transfer) the assigned background data transfer policy to the server 10. As illustrated in FIG. 8, a background data transfer response 806 transmitted to the server 10 may comprise the assigned background data transfer policy. In some embodiments, before the transmission of the assigned background data transfer policy to the server 10, the node 20 may check the action indicated by the BDT request 800 to determine if the action is acceptable. In some these embodiments, the node 20 may transmit the assigned background data transfer policy to the server 10 (e.g. via the exposure node 40) provided the action is acceptable. The process performed at block 804 can be performed according to current policy and charging control (PCC) procedures.

In embodiments where a plurality of assigned background data transfer policies are transmitted to the server 10, as mentioned earlier, the server 10 can select an assigned background transfer policy from the plurality of background data transfer policies. In some of these embodiments, such as that illustrated in FIG. 8, the server 10 can indicate to the exposure node 40 which assigned background transfer policy is selected, e.g. a further BDT request 808 may comprise an indication of which assigned background transfer policy is selected. The indication of which assigned background transfer policy is selected can be performed according to current policy and charging control (PCC) procedures. In some embodiments, in response to the server 10 indicating to the exposure node 40 which assigned background transfer policy is selected, the exposure node 40 may respond to the indication. For example, as illustrated in FIG. 8, the exposure node 40 may respond with a further background data transfer response 810. However, it will be understood that the further BDT request 808 and the further background data transfer response 810 may not be present in other embodiments, e.g. where only one background data transfer policy assigned is assigned for the transfer.

At block 812, the exposure node 40 forwards the BDT request 800 (or the further BDT request 808 according to some embodiments) to the node 20. The BDT request 800 (or the further BDT request 808 according to some embodiments) can be forwarded to the node 20 according to current policy and charging control (PCC) procedures. In some embodiments, the node 20 can be configured to store, in the repository 30 of the second network 404, the assigned background data transfer policy (or the selected one of the plurality of assigned background transfer policies according to some embodiments) and the indication of the action.

At block 814, when the server 10 wishes to initiate the transfer of background data from the server 10 to the user equipment, the server 10 contacts the node 20, e.g. via the exposure node 40. The server 10 may contact the node 20 according to current policy and charging control (PCC) procedures. The server 10 may contact the node 20 via a network interface, e.g. the Rx interface where the first and second network 402, 404 are part of an evolved packet core (EPC) or a 4G network, or the N5 interface where the first and second network 402, 404 are part of a 5G network. In some embodiments, the server 10 may contact the node 20 with a reference that identifies the assigned background data transfer policy (or the selected one of the plurality of assigned background transfer policies according to some embodiments). The node 20 acquires the assigned background data transfer policy (or the selected one of the plurality of assigned background transfer policies according to some embodiments) and the indication of the action to initiate for handling the transfer if the transfer fails to satisfy one or more conditions of the assigned background data transfer policy in the manner described earlier. In some embodiments, the node 20 may install policy and charging control (PCC) rules according to the one or more conditions of the assigned background data transfer policy.

The node 20 starts the monitoring of the transfer at block 814 to check whether the transfer satisfies the one or more conditions of the assigned background data transfer policy. Thus, in effect, the node 20 monitors the one or more conditions of the background data transfer policy. In some embodiments, the node 20 may subscribe to events in the enforcement or management node 50 of the second network 404 to receive information from the enforcement or management node 50 for use in checking whether the transfer satisfies the one or more conditions of the assigned background data transfer policy. The information may, for example, comprise usage reports, user equipment location changes, of any other information, or any combination of information, that can be used to check whether the transfer satisfies the one or more conditions of the assigned background data transfer policy. If the transfer fails to satisfy the one or more conditions of the assigned background data transfer policy (e.g. if the node 20 identifies that the one or more conditions are not fulfilled), the node 20 checks the action to initiate and then initiates the action. The one or more conditions may be any of those described earlier.

In some embodiment, if the transfer fails to satisfy the one or more conditions of the assigned background data transfer policy, the action may comprise disallowing (or terminating) the transfer. Thus, the node 20 disallows (or terminates) the transfer in these embodiments, e.g. via the network interface mentioned earlier. The node 20 may also remove the installed policy and charging control (PCC) rules in these embodiments. In other embodiments, if the transfer fails to satisfy the one or more conditions of the assigned background data transfer policy, the action may comprise allowing the transfer only according to one or more conditions of a default background data transfer policy of the node 20. In these embodiments, the node 20 may check the default background data transfer policy and modify the installed PCC rules according to the one or more conditions of the default background data transfer policy. In yet other embodiments, if the transfer fails to satisfy the one or more conditions of the assigned background data transfer policy, the action may comprise allowing the transfer only according to one or more revised conditions of the assigned background data transfer policy. In these embodiments, the node 20 may modify the installed PCC rules according to the one or more revised conditions of the assigned background data transfer policy. In some embodiments where the PCC rules are modified, the node 20 may apply a different charging for the modified PCC rules.

In some embodiments, at block 814, the node 20 may transmit to the server 10 a notification that the transfer fails to satisfy the one or more conditions of the assigned background data transfer policy. In some embodiments, the node 20 may transmit the notification to the exposure node 40 and the exposure node 40 may then notify the server 10 that the transfer fails to satisfy the one or more conditions of the assigned background data transfer policy.

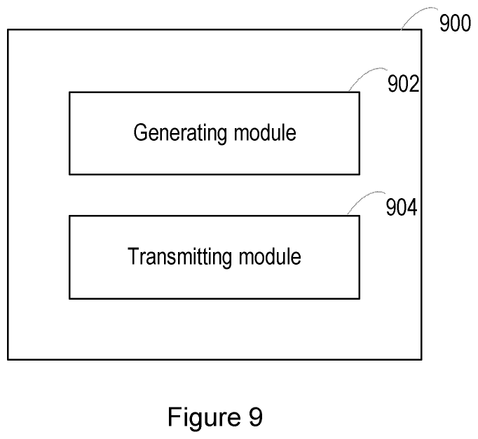

FIG. 9 is a block diagram illustrating a server 900 of a first network in accordance with an embodiment. The server 900 comprises a generating module 902 configured to generate an indication of an action to initiate for handling a transfer of background data from the server 900 to a user equipment if the transfer fails to satisfy one or more conditions of an assigned background data transfer policy for the transfer. The server 900 also comprises a transmitting module 904 configured to transmit the indication for a node of a second network to acquire the indication and initiate the action if the transfer fails to satisfy the one or more conditions of the assigned background data transfer policy.

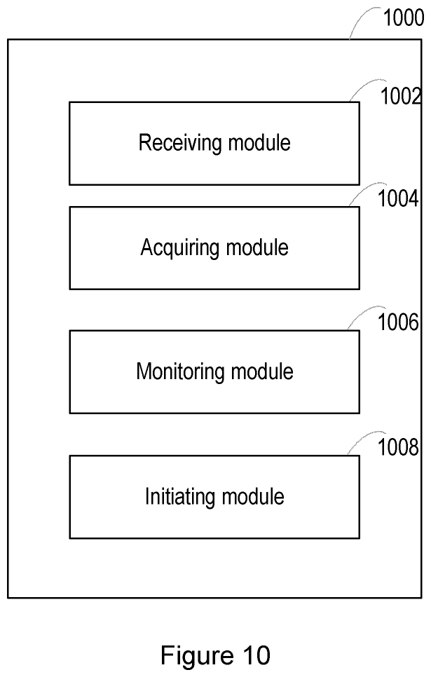

FIG. 10 is a block diagram illustrating a node 1000 of a second network in accordance with an embodiment. The node 1000 comprises a receiving module 1002 configured to receive, from a server 900 of a first network, a request to transfer background data from the server to a user equipment. The node 1000 also comprises an acquiring module 1004 configured to acquire an assigned background data transfer policy for the transfer and an indication generated by the server 900 of an action to initiate for handling a transfer if the transfer fails to satisfy one or more conditions of the assigned background data transfer policy. The node 1000 also comprises a monitoring module 1006 configured to monitor the transfer to check whether the transfer satisfies the one or more conditions of the assigned background data transfer policy. The node 1000 also comprises an initiating module 1008 configured to, if the transfer fails to satisfy the one or more conditions of the assigned background data transfer policy, initiate the action.

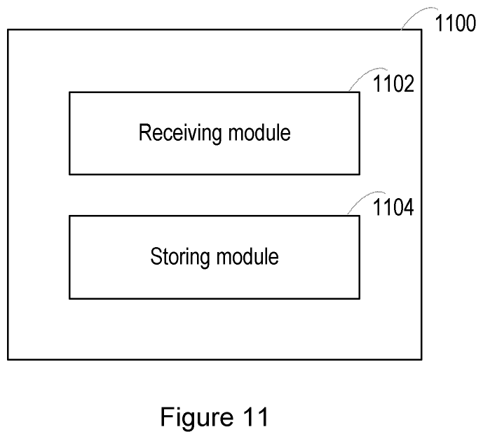

FIG. 11 is a block diagram illustrating a repository 1100 of a second network in accordance with an embodiment. The repository 1100 comprises a receiving module 1102 configured to receive a background data transfer policy assigned for a transfer of background data from a server 900 of a first network to a user equipment and an indication generated by the server 900 of an action to initiate for handling the transfer if the transfer fails to satisfy one or more conditions of the assigned background data transfer policy. The repository also comprises a storing module 1104 configured to store the assigned background data transfer policy and the indication of the action for a node 1000 of a second network to acquire in order to initiate the action if the transfer fails to satisfy the one or more conditions of the assigned background data transfer policy.

The network functionality described herein can be performed by hardware. Thus, the network 400, 402, 404 can be a hardware network. For example, the server 10, 900 can be a hardware server, the node 20, 1000 can be a hardware node, the repository 30, 1100 can be a hardware repository, the exposure node 40 can be a hardware exposure node, and/or the enforcement or management node 50 can be a hardware enforcement or management node.

However, it will also be understood that at least part or all of the network functionality described herein can be virtualized. For example, the functions performed within the network 400, 402, 404 (e.g. by any one or more of the server 10, 900, the node 20, 1000, the repository 30, 1100, the exposure node 40, and enforcement or management node 50) can be implemented in software running on generic hardware that is configured to orchestrate the network functionality. Thus, in some embodiments, the network 400, 402, 404 can be a virtual network. In these embodiments, the server 10, 900 can be a virtual server, the node 20, 1000 can be a virtual node, the repository 30, 1100 can be a virtual repository, the exposure node 40 can be a virtual exposure node, and/or the enforcement or management node 50 can be a virtual enforcement or management node. In some embodiments, at least part or all of the network functionality described herein may be performed in a network enabled cloud.

There is also provided a computer program product comprising a carrier containing instructions for causing processing circuitry to perform at least part of the method described herein. In some embodiments, the carrier can be any one of an electronic signal, an optical signal, an electromagnetic signal, an electrical signal, a radio signal, a microwave signal, or a computer-readable storage medium.

Thus, in the manner described herein, it is possible to negotiate and make use of a transfer policy that allows a server to transfer background data to a user equipment under certain conditions. Moreover, appropriate action is taken when it is determined that one or more of these conditions are broken to advantageously enable an optimum background data transfer. There is thus advantageously provided herein an improved mechanism for handling a background data transfer.

It should be noted that the above-mentioned embodiments illustrate rather than limit the idea, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1.-20. (canceled)

21. A method of operating a server of a first network, the method comprising:
generating an indication of an action to initiate for handling a transfer of background data from the server to a user equipment if the transfer fails to satisfy one or more conditions of an assigned background data transfer policy for the transfer; and
transmitting the indication for a node of a second network to acquire the indication and initiate the action if the transfer fails to satisfy the one or more conditions of the assigned background data transfer policy.

22. A method as claimed in claim 21, the method further comprising:
if the transfer fails to satisfy the one or more conditions of the assigned background data transfer policy, receiving a notification from the node that the transfer fails to satisfy the one or more conditions of the assigned background data transfer policy.

23. A server of a first network, the server comprising processing circuitry, wherein the processing circuitry is configured to:
generate an indication of an action to initiate for handling a transfer of background data from the server to a user equipment if the transfer fails to satisfy one or more conditions of an assigned background data transfer policy for the transfer; and
transmit the indication for a node of a second network to acquire the indication and initiate the action if the transfer fails to satisfy the one or more conditions of the assigned background data transfer policy.

24. A method of operating a node of a second network, the method comprising:
receiving, from a server of a first network, a request to transfer background data from the server to a user equipment;
acquiring an assigned background data transfer policy for the transfer and an indication generated by the server of an action to initiate for handling the transfer if the transfer fails to satisfy one or more conditions of the assigned background data transfer policy;
monitoring the transfer to check whether the transfer satisfies the one or more conditions of the assigned background data transfer policy; and
if the transfer fails to satisfy the one or more conditions of the assigned background data transfer policy, initiating the action.

25. A method as claimed in claim 24, wherein the one or more conditions of the assigned background data transfer policy comprise any one or more of:
a maximum volume of background data for the transfer;
a maximum duration for the transfer; and
a predefined area within the second network for the transfer.

26. A method as claimed in claim 25, wherein:
the one or more conditions of the assigned background data transfer policy comprise a maximum volume of background data for the transfer; and
the action is initiated if the volume of background data for the transfer exceeds the maximum volume.

27. A method as claimed in claim 25, wherein:
the one or more conditions of the assigned background data transfer policy comprise a maximum duration for the transfer; and
wherein the action is initiated if the duration of the transfer exceeds the maximum duration.

28. A method as claimed in claim 25, wherein:
the one or more conditions of the assigned background data transfer policy comprise a predefined area within the second network for the transfer; and
the action is initiated if the transfer occurs outside the predefined area within the second network.

29. A method as claimed in claim 24, wherein the action comprises:
disallowing the transfer;
allowing the transfer only according to one or more conditions of a default background data transfer policy of the node; or
allowing the transfer only according to one or more revised conditions of the assigned background data transfer policy, wherein the one or more revised conditions are indicated by the server.

30. A method as claimed in claim 24, the method further comprising:
if the transfer fails to satisfy the one or more conditions of the assigned background data transfer policy, transmitting a notification to the server of the first network that the transfer fails to satisfy the one or more conditions of the assigned background data transfer policy.

31. A method as claimed in claim 24, the method further comprising:
A method of operating a repository of a second network, the method comprising:
transmitting to a repository of the second network the assigned background data transfer policy for a transfer of background data from the server of the first network to the user equipment and the indication generated by the server of an action to initiate for handling the transfer if the transfer fails to satisfy one or more conditions of the assigned background data transfer policy;
wherein the assigned background data transfer policy and the indication of the action for a node of the second network to acquire in order to initiate the action if the transfer fails to satisfy the one or more conditions of the assigned background data transfer policy are stored in the repository.

32. A node of a second network, the node comprising processing circuitry, wherein the processing circuitry is configured to:
receive, from a server of a first network, a request to transfer background data from the server to a user equipment;
acquire an assigned background data transfer policy for the transfer and an indication generated by the server of an action to initiate for handling a transfer if the transfer fails to satisfy one or more conditions of the assigned background data transfer policy;
monitor the transfer to check whether the transfer satisfies the one or more conditions of the assigned background data transfer policy; and
if the transfer fails to satisfy the one or more conditions of the assigned background data transfer policy, initiate the action.

33. A node as claimed in claim 32, wherein the one or more conditions of the assigned background data transfer policy comprise any one or more of:
a maximum volume of background data for the transfer;
a maximum duration for the transfer; and
a predefined area within the second network (404) for the transfer.

34. A node as claimed in claim 33, wherein:
the one or more conditions of the assigned background data transfer policy comprise a maximum volume of background data for the transfer; and
the processing circuitry is configured to initiate the action if the volume of background data for the transfer exceeds the maximum volume.

35. A node as claimed in claim 33, wherein:
the one or more conditions of the assigned background data transfer policy comprise a maximum duration for the transfer; and
the processing circuitry is configured to initiate the action to the user equipment if the duration of the transfer to the user equipment exceeds the maximum duration.

36. A node as claimed in claim 33, wherein:
the one or more conditions of the assigned background data transfer policy comprise a predefined area within the second network for the transfer; and
the processing circuitry is configured to initiate the action if the transfer occurs outside the predefined area within the second network.

37. A node as claimed in claim 32, wherein the action comprises:
disallowing the transfer;
allowing the transfer only according to one or more conditions of a default background data transfer policy of the node; or
allowing the transfer only according to one or more revised conditions of the assigned background data transfer policy, wherein the one or more revised conditions are indicated by the server.

38. A node as claimed in claim 32, wherein the processing circuitry is further configured to:
if the transfer fails to satisfy the one or more conditions of the assigned background data transfer policy, transmit a notification to the server of the first network that the transfer fails to satisfy the one or more conditions of the assigned background data transfer policy.

39. A node as claimed in claim 32, wherein the processing circuitry is further configured to:
transmit to a repository of the second network the background data transfer policy assigned for a transfer of background data from the server of the first network to the user equipment and the indication generated by the server of an action to initiate for handling the transfer if the transfer fails to satisfy one or more conditions of the assigned background data transfer policy;
wherein the assigned background data transfer policy and the indication of the action for a node of the second network to acquire in order to initiate the action if the transfer fails to satisfy the one or more conditions of the assigned background data transfer policy are stored in the repository.
